(19) United States
(12) Patent Application Publication
(10) Pub. No.: US 2005/0287303 A1
(43) Pub. Date: Dec. 29, 2005

(54) Tire dressing fluid composition and method of applying

(76) Inventor: William M. Gorra, West Hartford, CT (US)

Correspondence Address: MCCORMICK, PAULDING & HUBER LLP, CITY PLACE II, 185 ASYLUM STREET, HARTFORD, CT, 06103, US

(21) Appl. No.: 10/869,360

(22) Filed: Jun. 16, 2004

(51) Int. Cl. B05D 1/28

(52) U.S. Cl. 427/429; 106/287.1

(57) ABSTRACT

A method of dressing a sidewall of a tire of a vehicle comprises the steps of pumping a non-emulsified blend of silicone fluids into an applicator pad; engaging a face of the applicator pad with the sidewall of a tire of a vehicle; moving the tire and the applicator pad relative to one another to rub the tire sidewall and the face of the applicator pad against each other and spreading the non-emulsified blend of silicone fluids over the sidewall as a tire dressing; and disengaging the tire from the applicator pad after spreading the non-emulsified blend on the sidewall. A composition for dressing a sidewall of a tire of a vehicle comprises a first silicone fluid having a characteristic viscosity and a second silicone fluid having a characteristic viscosity, wherein the characteristic viscosity of the first silicone fluid is substantially disparate from the characteristic viscosity of the second silicone fluid, and wherein the first and second silicone fluids are mixed to form a non-emulsified blend.

### TECHNICAL FIELD

This invention pertains generally to tire dressing applications and more particularly to a method of applying a tire dressing fluid and to a composition for a tire dressing fluid.

### BACKGROUND OF THE INVENTION

It is well known in the vehicle washing industry to perform various automated steps during a vehicle washing process as the vehicle is conveyed through a washing facility. Numerous advances to such washing facilities have improved the automated vehicle washing process while decreasing the manpower requirements of the facility. For example, apparatuses and processes have been developed to provide for the automatic application of various compositions to the sidewalls of the tires of the vehicles to dress the tires. As is used herein, the term “dress” as applied to tires means the application of a composition to enhance the appearance of the tire by providing a sheen to the surface of the tire and to provide a protective barrier to the tire material, thereby possibly prolonging the life of the tire.

Tire dressing compositions of the prior art have typically been water-based, solvent-based, or a mixture of water- and solvent-based formulations. Those compositions that have been water-based have typically been characterized as colloidal suspensions of a rubber-type polymer with a small amount of silicone fluid and a tackifying agent mixed therein. Because of the nature of suspensions, the polymer typically settles out of the liquid phase, thereby requiring the composition to be agitated (e.g., mixed or shaken) prior to use. Furthermore, because silicone fluids are generally immiscible in water, a layering effect that further requires agitation is often observed. Compositions that have been solvent-based, while providing superior performance when compared to any tire dressing composition have an aqueous phase, have generally been difficult to apply and further often pose health risks to users of the compositions.

Other tire dressing compositions have been comprised of blends of liquid siloxane polymers (silicone fluids) in which the various silicone components have been long chain molecules and cyclic molecules having substantially disparate molecular weights. In such compositions, the mixtures of the silicone fluids have been emulsified and/or have been made to include propellants to facilitate the application of the compositions to the tire surface to be dressed. The emulsification of the silicone fluids has, however, generally hindered the applicability of the compositions (particularly with regard to the spraying of the compositions). Furthermore, the inclusion of propellants have undesirably added cost to the compositions and have also detracted from the overall performance of the products.

What is needed is an easily applicable tire dressing composition that provides superior performance relative to prior art tire dressing compositions.

### SUMMARY OF THE INVENTION

In one aspect of the present invention, a method of dressing a sidewall of a tire of a vehicle includes the steps of pumping a non-emulsified blend of silicone fluids into an applicator pad; engaging a face of the applicator pad with the sidewall of the tire; moving the tire and the applicator pad relative to one another to spread the fluid over the sidewall as a tire dressing; and disengaging the tire from the applicator pad after spreading the fluid.

In another aspect of the present invention, a composition for dressing a sidewall of a tire of a vehicle includes a first silicone fluid having a characteristic viscosity and a second silicone fluid having a characteristic viscosity. The characteristic viscosities of each fluid are substantially disparate from each other. In particular, the first silicone fluid has a viscosity of about 10,000 centistokes (cst) and comprises about 10 weight percent (wt. %) of the total composition and the second silicone fluid has a viscosity of about 100 cst and comprises about 90 wt. % of the total composition. Furthermore the first and second silicone fluids are mixed to form a non-emulsified blend.

One advantage of the present invention is that a substantial cost savings can be realized. In particular, because the tire dressing composition is a blend of siloxane polymers that is not emulsified, a finer spray can be applied through a nozzle and correspondingly more evenly wicked through the foam structure of the applicator pad. Consequently, the application of excess and unnecessary composition is avoided, and less waste is generated.

Another advantage of the present invention is that a higher quality dressing can be applied to the sidewall surfaces of a tire. More specifically, a more uniform hydrophobicity throughout the structure of the foam of the applicator pad is achieved, thereby resulting in an increased water repelling function of the pad at the tire-contacting surface. Accordingly, there is less opportunity for errant water streams (e.g., water spray from the actual vehicle washing process or splashed from the vehicle or ground) to contact and remain on the applicator pad during the tire dressing operation. Thus, because little or no water is allowed to absorb onto the pad, a more uniform application of the silicone composition is applied to the tire (alternating areas of high- and low gloss are avoided), thereby resulting in a more uniform and higher-quality luster.

### BRIEF DESCRIPTION OF THE DRAWINGS

FIG. 1 is a schematic plan view of a tire dressing assembly showing a vehicle moving toward left and right tire dressing applicators.

FIG. 2 is a perspective view of the tire dressing assembly of FIG. 1 showing the vehicle engaged with the right tire dressing applicator.

FIG. 3 is a cross-sectional view of the tire dressing apparatus of FIGS. 1 and 2.

FIG. 4 is a cross-sectional view of the tire dressing apparatus of FIG. 3 showing the applicator pad clamped between upper and lower mount plates.

### DETAILED DESCRIPTION OF THE PREFERRED EMBODIMENT

In one aspect, the present invention is directed to the application of a fluid composition to a rubber or vinyl surface by the transfer of the composition onto an applicator pad and to the rubber or vinyl surface in a contacting operation using an automatic tire dressing apparatus. One such apparatus is disclosed in U.S. Pat. No. 6,461,429 to Gorra, which is incorporated herein by reference. Although the invention as described below refers to the application of a siloxane polymer composition to the appearance surfaces of the tires of a motor vehicle via a foam applicator pad to provide a dressing for the tires, it should be understood that the composition as described herein may be applied to any rubber or vinyl surface.

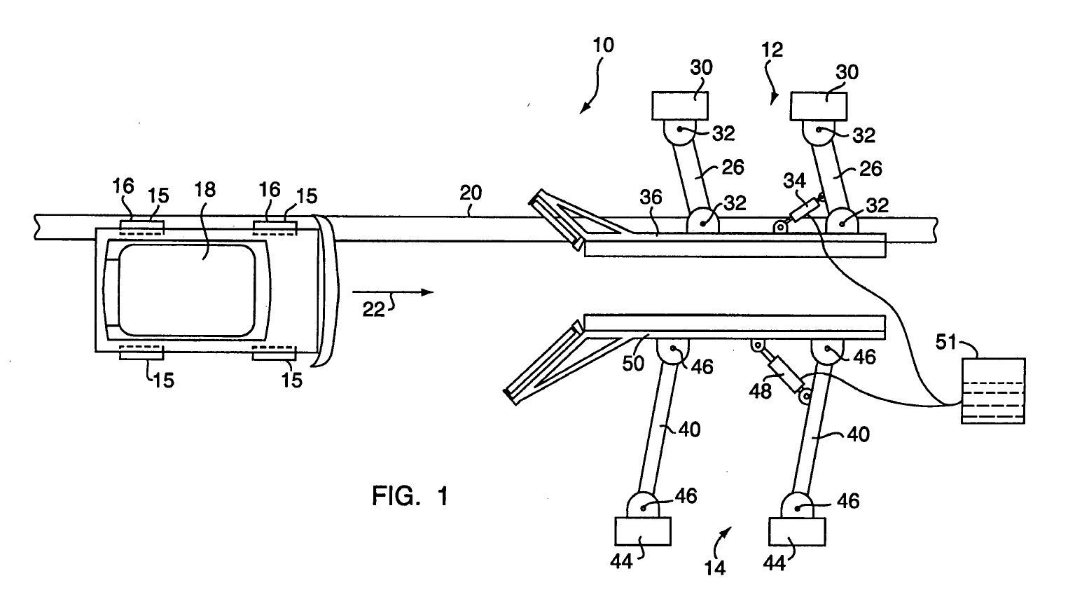

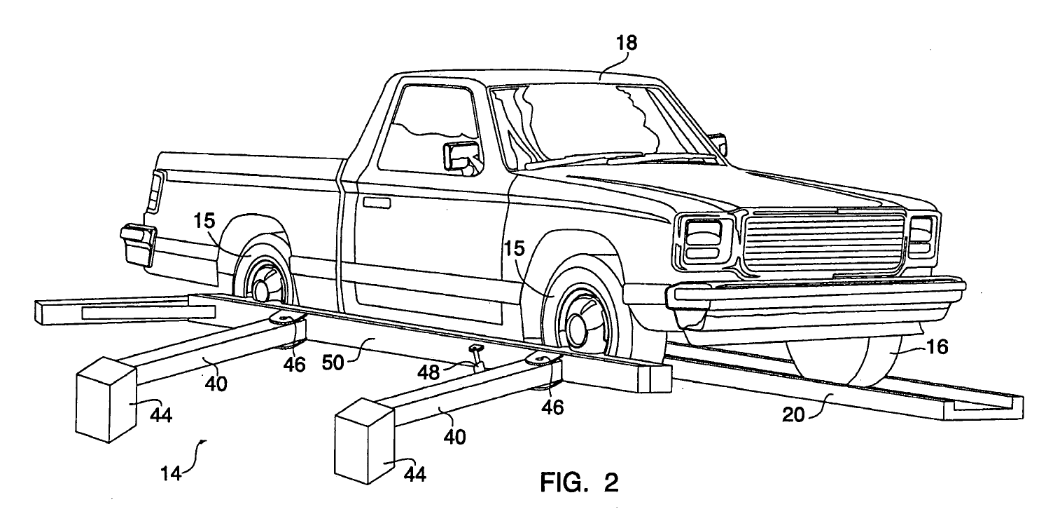

Referring to FIGS. 1 and 2, an assembly configured to apply the siloxane polymer composition to the tires of a vehicle is shown generally at 10 and is hereinafter referred to as “assembly 10.” The assembly 10 includes a left applicator 12 and a right applicator 14 that cooperate to apply the composition to the sidewalls 15 of tires 16 of the vehicle, which is shown at 18. The vehicle 18 may be conveyed along a track 20 in a vehicle washing facility. The track 20 may include an arrangement of components (e.g., a computer control system, automatic conveying equipment, sensing equipment, and the like) that move the vehicle 18, monitor its position, and control the application of the composition to the tires 16.

As the vehicle 18 moves into the assembly 10 in the direction shown by an arrow 22, the left and right applicators 12, 14 are engaged by the vehicle 18. The left applicator 12 includes a mount bar 36 that is mounted via a pair of swing arms 26 and associated pivot assemblies 32 to anchor posts 30. The right applicator 14 includes a mount bar 50 that is mounted via a pair of swing arms 40 and associated pivot assemblies 46 to anchor posts 44. As the vehicle 18 moves through the assembly 10, as is shown in FIG. 2, the applicators 12, 14 are deflected to the outer surfaces of the tires 16 at their respective left- and right sides of the vehicle 18. Preferably, hydraulically-actuated cylinders 34, 48 are mounted between at least one of each of the swing arms 26, 40 and its associated mount bar 36, 50 to provide a controlled amount of pressure (via a control device 51) to the tires 16 on each side of the vehicle 18. Other devices (e.g., springs) are also within the scope of the invention to provide pressure to the tires 16. Applicator pads are attached to face surfaces of each of the mount bars 36, 50 to provide the contact between the respective applicators 12, 14 and the tires 16. As the vehicle 18 moves out of the assembly 10, the bias exerted on the applicators 12, 14 by the vehicle 18 is relieved.

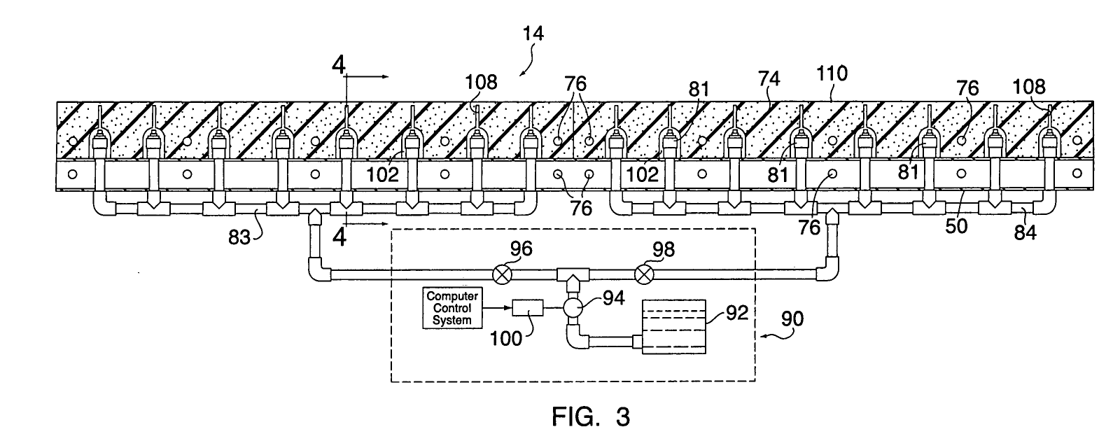

Referring now to FIG. 3, the right applicator 14 includes a plurality of spray nozzles 81 mounted along a length of the mount bar 50 such that the outlet ends of the spray nozzles 81 extend into the applicator pads, which are shown at 74, and which are bolted to the mount bar 50 with mount bolts 76. Preferably, the nozzle openings are dimensioned to accommodate the spraying of the composition at about 0.07 gallons per minute (gpm) to about 0.13 gpm and preferably at about 0.09 gpm to about 0.11 gpm at a pressure of about 30 pounds per square inch gauge (psig) to about 50 psig, and preferably about 35 psig to about 45 psig. Each nozzle 81 is mounted such that it extends through the mount bar 50 and into an orifice 102 of the applicator pad 74. Some of the nozzles 81 are connected to a forward supply line 83, whereas the remaining nozzles 81 are connected to a rear supply line 84. Each of the supply lines 83, 84 is connected to a fluid supply system 90 that supplies each nozzle 81. The fluid supply system 90 includes a reservoir 92 in which the composition is stored, a pump 94 that forces the composition to the nozzles 81, and valves 96, 98 that control the fluid flow to the front and rear supply lines 83, 84, respectively. The reservoir 92 is preferably a bulk source of the composition (e.g., a fifty-five gallon drum, a tote, a carboy, or the like). The pump 94 is actuated by the computer control system of the washing facility.

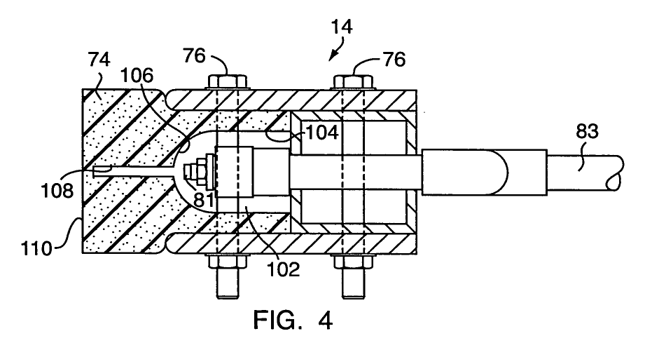

Referring now to FIG. 4, one exemplary embodiment of an applicator pad 74 of the right applicator 14 is shown. The applicator pad 74 is configured with a plurality of orifices 102 that each receive a nozzle 81 such that fluid received from the supply line 83 and sprayed from the nozzles 81 is dispersed inside the orifice 102 and into the foam of the applicator pad 74. Each orifice 102 has a cylindrical portion 104, an end portion 106, and a capillary 108 that extends from the end portion 106 toward a contact surface 110 at a face of the applicator pad 74 (the surface of the applicator pad 74 that contacts the tire). The capillary 108 terminates at a point approximately 0.25 in. short of the contact surface 110, thereby allowing fluid sprayed or wicked into the capillary 108 to be absorbed by the applicator pad 74 and wicked to the face of the pad 74. Although the applicator pad 74 is shown as having the nozzles 81 received in orifices 102 at the rear portions of the pad 74, it should be understood that the fluid can be sprayed or otherwise applied to any portion of the pad 74.

Preferably, the foam of the applicator pad 74 is a reticulated foam. As is used herein, the term “reticulated foam” means a solid having a cell structure that defines a porosity and in which the cells can be open, closed, or a combination thereof to provide flexibility to the solid, to allow for its compression, and to allow it to retain liquids.

In another aspect, the present invention is directed to a composition that comprises a non-aqueous non-solvent blend of siloxane polymers that can be pumped into, sprayed on, or otherwise transferred to the applicator pads 74. A siloxane polymer is based on a structure having alternating silicon and oxygen atoms with various organic radicals attached to the silicon atoms. A formula of an exemplary siloxane polymer is 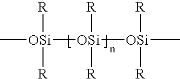
where R is any organic radical (e.g., a methyl group, an ethyl group, or the like) that may be the same or different.

The application of the composition to the applicator pads 74 thereby renders the pads 74 uniformly waterproof. The siloxane polymers are of varying Theological characteristics. In particular, the composition is a non-emulsified blend of silicone fluids of substantially disparate viscosities so as to preferably facilitate the spraying of the composition through the nozzles 81 and into the applicator pad 74. Once sprayed onto the foam of the applicator pad 74, the composition permeates the cell structure of the foam to create a barrier that repels water and prevents it from being absorbed into the foam.

The blend preferably comprises two silicone fluids, namely a high viscosity silicone fluid and a low viscosity silicone fluid. In alternate embodiments, however, the blend may comprise three or more silicone fluids wherein one of the fluids has a high viscosity, one of the fluids has a low viscosity, and the remaining fluids have any combination of high, low, and intermediate viscosities. As is used herein, the term “high viscosity” means a viscosity over about 5,000 centistokes (cst), and the term “low viscosity” means a viscosity that is about 5,000 cst or less. In the preferred blend, the high viscosity fluid has a viscosity of about 9,000 cst to about 11,000 cst, preferably about 9,500 cst to about 10,500 cst, and even more preferably about 9,800 cst to about 10,200 cst. Also in the preferred blend, the low viscosity fluid has a viscosity of about 80 cst to about 150 cst, preferably about 90 cst to about 120 cst, and more preferably about 95 cst to about 110 cst. The blending of the silicone fluids having such viscosities provides a composition having a final product viscosity that facilitates the retention of unapplied portions of the composition in the pores of the reticulated foam of the applicator pad, thereby enhancing the overall hydrophobicity of the applicator pad. The fluids are blended so as to be about 5 weight percent (wt. %) to about 15 wt. % of the high viscosity polymer and about 85 wt. % to about 95 wt. % of the low viscosity polymer and preferably about 9.5 wt. % to about 10.5 wt. % of the high viscosity polymer and about 89.5 wt. % to about 90.5 wt. % of the low viscosity polymer.

The composition may further include a colorant (e.g., a dye, indicator, or the like) in an amount sufficient to provide a color to the composition without interfering with the tire dressing functions of the silicone fluids. For example, depending upon the strength of the colorant, a blue dye is added in an amount of about 0.001 wt. % to about 0.1 wt. %. The composition may additionally or alternatively include a perfume or the like to impart an odor thereto.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A method of dressing a sidewall of a tire of a vehicle, the method comprising the steps of:
pumping a non-emulsified blend of silicone fluids into an applicator pad;
engaging a face of said applicator pad with the sidewall of a tire of a vehicle;
moving said tire and said applicator pad relative to one another to rub said tire sidewall and said face of said applicator pad against each other and spreading the non-emulsified blend of silicone fluids over said sidewall as a tire dressing; and
disengaging said tire from said applicator pad after spreading said non-emulsified blend on said sidewall.

2. The method of claim 1, wherein said pumping of said non-emulsified blend of silicone fluids comprises spraying said non-emulsified blend of silicone fluids into an orifice in said applicator pad.

3. The method of claim 2, wherein said non-emulsified blend of silicone fluids is sprayed through a nozzle at about 0.07 gpm to about 0.13 gpm.

4. The method of claim 2, wherein said non-emulsified blend of silicone fluids is sprayed through a nozzle at about 0.09 gpm to about 0.11 gpm.

5. The method of claim 2, wherein said non-emulsified blend of silicone fluids is sprayed at about 30 psig to about 50 psig.

6. The method of claim 2, wherein said non-emulsified blend of silicone fluids is sprayed at about 35 psig to about 45 psig.

7. The method of claim 1, wherein said applicator pad has a foam structure, and further comprising the step of wicking said non-emulsified blend of silicone fluids through said foam structure of said applicator pad to said face of said applicator pad.

8. The method of claim 1, wherein said non-emulsified blend of silicone fluids comprises,
a first silicone fluid having a viscosity of about 9,000 cst to about 11,000 cst, and
a second silicone fluid having a viscosity of about 80 cst to about 150 cst.

9. The method of claim 1, wherein said applicator pad is porous, and wherein the step of pumping comprises pumping said non-emulsified blend of silicone fluids into said applicator pad at a location other than at an orifice at a rear portion of said applicator pad, whereby the porosity of said applicator pad wicks said non-emulsified blend of silicone fluids to said face of said applicator pad for a more uniform application of said fluids to said sidewall.

10. The method of claim 1, wherein said non-emulsified blend of silicone fluids comprises about 9.5 wt. % to about 10.5 wt. % of a first silicone fluid and about 89.5 wt. % to about 90.5 wt. % of a second silicone fluid.

11. The method of claim 1, further comprising retaining an unapplied portion of said non-emulsified blend of silicone fluids in said applicator pad.

12. A composition for dressing a sidewall of a tire of a vehicle, said composition comprising:
a first silicone fluid having a characteristic viscosity; and
a second silicone fluid having a characteristic viscosity;
wherein said characteristic viscosity of said first silicone fluid is substantially disparate from said characteristic viscosity of said second silicone fluid, and wherein said first and second silicone fluids are mixed to form a non-emulsified blend.

13. The composition of claim 12, wherein said characteristic viscosity of said first silicone fluid is high in viscosity and said characteristic viscosity of said second silicone fluid is low in viscosity.

14. The composition of claim 12, wherein said first silicone fluid has a viscosity of about 9,000 cst to about 11,000 cst, and said second silicone fluid has a viscosity of about 80 cst to about 150 cst.

15. The composition of claim 14, wherein said composition comprises about 5 wt. % to about 15 wt. % of said first silicone fluid and about 85 wt. % to about 95 wt. % of said second silicone fluid.

16. The composition of claim 14, wherein said composition comprises about 9.5 wt. % to about 10.5 wt. % of said first silicone fluid and about 89.5 wt. % to about 90.5 wt. % of said second silicone fluid.

17. The composition of claim 12, further comprising a colorant.

18. The composition of claim 12, further comprising a perfume.

19. The composition of claim 12, further comprising a third silicone fluid having a characteristic viscosity.
